(19) United States
(12) Patent Application Publication
(10) Pub. No.: US 2025/0060689 A1
(43) Pub. Date: Feb. 20, 2025

(54) Producing Identity Markers by Electrostatic Printing

(71) Applicant: DUST Identity, Inc., Newton, MA (US)

(72) Inventors: Jacob Kohl, Framingham, MA (US); Ophir Gaathon, Needham, MA (US); Benjamin Lawson, Brookline, MA (US); Ryan Vincent, Framingham, MA (US); Jonathan Hodges, Princeton, NJ (US)

(73) Assignee: DUST Identity, Inc., Newton, MA (US)

(21) Appl. No.: 18/884,412

(22) Filed: Sep. 13, 2024

Related U.S. Application Data
(63) Continuation of application No. PCT/US2023/014093, filed on Feb. 28, 2023.
(60) Provisional application No. 63/319,835, filed on Mar. 15, 2022.

(51) Int. Cl. G03G 15/08; G03G 15/00; G03G 15/20

(52) U.S. Cl. CPC G03G 15/0822; G03G 15/2064; G03G 15/5062

(57) ABSTRACT

In a general aspect, identity markers containing identity-forming particles are created by electrostatic printing processes. In some aspects, a toner mixture is received on an electrostatically charged surface of an image transfer drum in an electrostatic printer system. The toner mixture includes fusible particles and diamond particles. The toner mixture is held to the electrostatically charged surface by an electrostatic force. The toner mixture is transferred onto a substrate from the electrostatically charged surface of the image transfer drum. The toner mixture is bonded to the substrate by operation of a fuser assembly of the electrostatic printer system. When the toner mixture is bonded onto the substrate, the fusible particles fuse to each other, thereby forming a host matrix that secures the diamond particles at fixed locations in the host matrix.

### CROSS-REFERENCE TO RELATED APPLICATIONS

This application claims priority to U.S. Provisional Patent Application No. 63/319,835, filed Mar. 15, 2022, entitled “Producing Identity Markers by Electrostatic Printing.” The above-referenced priority document is incorporated herein by reference.

### BACKGROUND

The following description relates to producing identity markers using electrostatic printing processes.

Some products are produced with holograms, watermarks, fluorescent dyes, or other features that can be used as anti-counterfeiting measures. For example, such features may be used to verify the source or authenticity of products. Such measures are important in a number of industries including food, pharmaceuticals, electronics, luxury goods, and others.

### BRIEF DESCRIPTION OF DRAWINGS

FIG. 1A is a schematic diagram showing a perspective view of an example object that includes an identity marker.

FIG. 1B is a schematic diagram showing aspects of an example system.

FIG. 2A is a schematic diagram showing aspects of an example electrostatic printer system.

FIG. 2B is a schematic diagram showing aspects of an example electrostatic printer system.

FIG. 3A is a microscopic reflected-light optical image showing a portion of an example identity marker created by an electrostatic printing process.

FIG. 3B is a microscopic reflected-light optical image showing a portion of an example identity marker created by an electrostatic printing process.

FIG. 4 is a flow chart showing aspects of an example process for producing identity markers.

### DETAILED DESCRIPTION

In some aspects of what is described here, an identity marker that uniquely identifies an object is produced by an electrostatic printer system. The identity marker may be produced on a substrate that can be attached to a surface of the object, or the identity marker can be printed directly on the surface of the object. The electrostatic printer system can include a toner cartridge that contains a mixture of fusible and non-fusible particles. The mixture can be deposited onto a surface and then bonded to the surface to form an identity marker. For instance, the fusible particles can be melted and hardened on the surface to embed the non-fusible particles at fixed locations in the identity marker. When the mixture is deposited onto the substrate, the non-fusible particles are randomly distributed in the mixture, and consequently, the non-fusible particles become randomly distributed in the identity marker as well. In some implementations, non-fusible particles includes identity-forming particles, e.g., non-fusible particles with properties that enable them to be used for identification purposes. The fixed, random distribution of identity-forming particles in the identity marker can provide a unique and unclonable identity for the object. In some implementations, the identity-forming particles are diamond particles. In some cases, identity-forming particles may include other materials. For example, identity-forming particles may be composed of silicon, alumina, iron oxide, gold, or other materials.

In some implementations, the systems and techniques described here can provide technical advantages and improvements over conventional printing techniques. Since inkjet technology dispenses small, metered droplets of liquid ink, particles must be suspended in the liquid and must flow through the microchannels of the inkjet print heads. These particles, especially larger particles, have a strong tendency to separate from liquid mixtures, in a toner cartridge absent of agitation, in the time scales necessary for practical printing. Particles with sizes comparable to the microchannels of the inkjet print heads may also tend to clog these channels. Since electrostatic printers are specifically designed to handle and deposit dry particles, they are well suited for incorporation of non-fusible identity-forming particles. Dry mixtures of non-fusible particles and fusible toner particles do not suffer from natural separation (e.g., distributed through gravity induced separation) as do liquid mixtures used for printing. In some implementations, the techniques and methods presented here can provide a complex, random, or quasi-random process for distributing a collection of identity-forming particles as an identity marker. Accordingly, the distribution of the identity-forming particle properties in an identity marker would generally be difficult or impractical (or even impossible) to clone or duplicate in another identity marker. Thus, the distribution of the identity-forming particle properties can be unique and unclonable for each individual identity marker, and may serve as a unique and unclonable identifier of an object that the identity marker is associated with, akin to a fingerprint or signature, for identification and authentication purposes.

In some examples, identity markers can provide a more covert, secure mechanism for product tracking and authentication. By integrating a unique tag onto the surfaces of packaging or a product itself, businesses may be able to track raw materials, components, and products (e.g., throughout the entire product lifecycle) in a secure manner. In some cases, products can be tracked using a mechanism that is not easily compromised, and does not interfere with the product's function or aesthetic. In some cases, an identity marker can be scanned or interrogated repeatedly and quickly, which may allow more efficient and reliable serialized tracking.

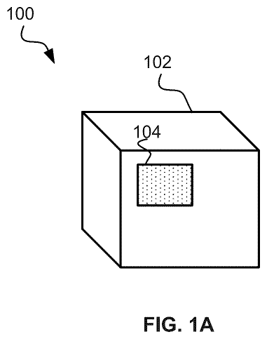

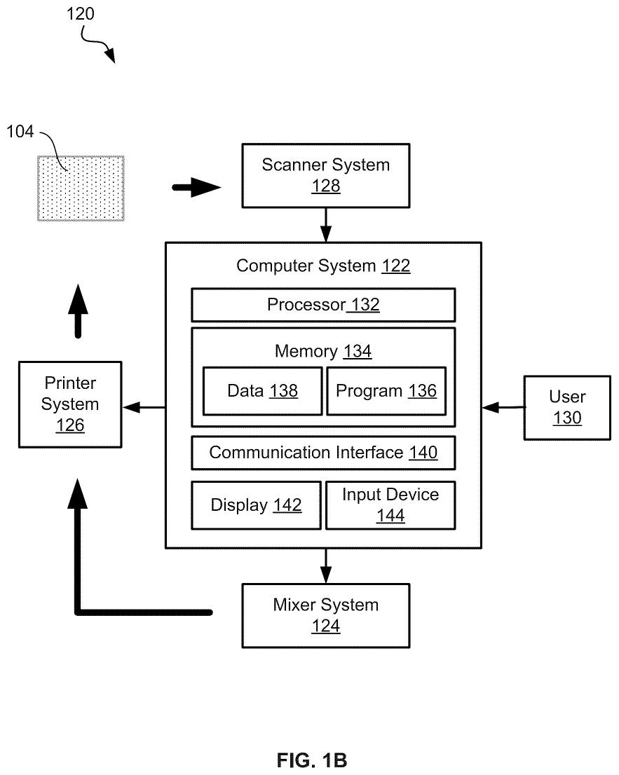

FIG. 1A is a schematic diagram showing a perspective view of an example object 102. The example object 102 includes an identity marker 104. The example object 102 and identity marker 104 shown in FIG. 1A may generally have any size and shape. In some implementations, the object 102 is a product or a product package. In some cases, manufacturers can tailor specific features and locations on the object 102 to contain an identity marker 104. When the identity marker 104 is created and associated (e.g., attached, fastened, adhered, integrated, printed, or embedded) to the object 102, elements in the identity marker 104 that contain unique and unclonable features can be scanned (e.g., using an imaging system or another type of scanner system) and used to provide a security fingerprint for the associated object 102.

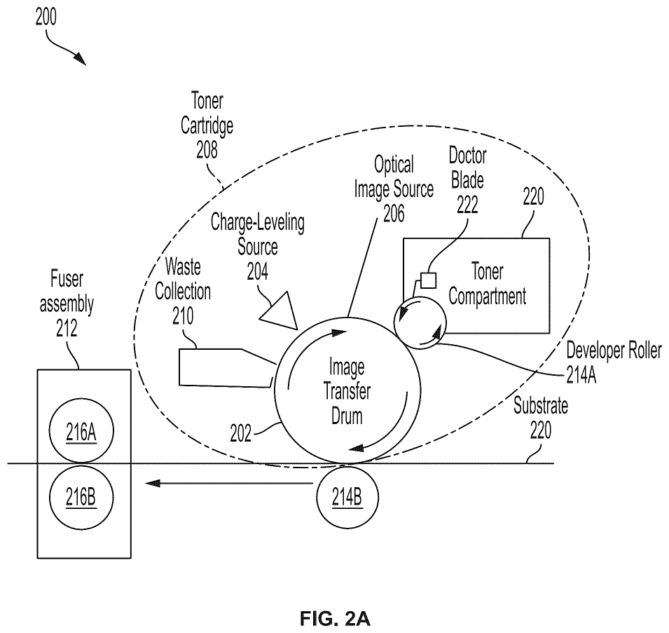

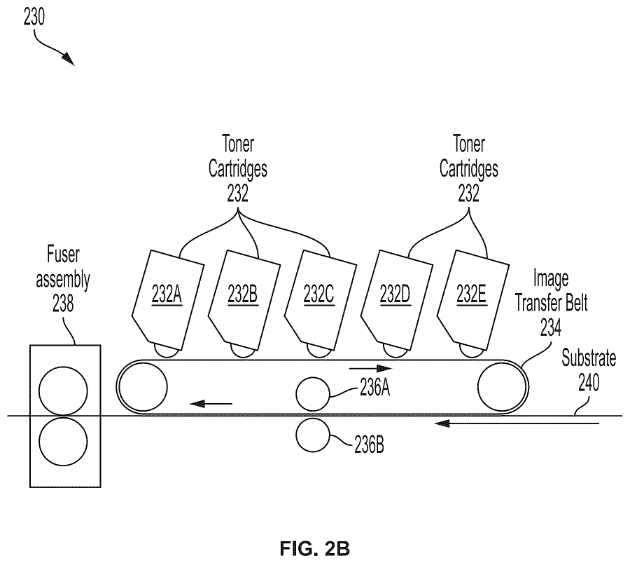

As shown in FIG. 1A, the identity marker 104 resides on the surface of the object 102. In some implementations, the identity marker 104 is created using an electrostatic printer system (e.g., the electrostatic printer system 200 in FIG. 2A). In some cases, the identity marker 104 can be formed on a substrate, which may be made of any solid material (e.g., metal, paper, plastic, wood, leather, etc.). The substrate can then be attached to the surface of the object 102. In some implementations, the identity marker 104 can be directly printed on the object 102 (e.g., at designated regions on a surface of the object 102). In some cases, the identity marker 104 may be embedded internally (e.g., under the exterior surface) within the object 102. In some other instances, the identity marker 104 may be integrated onto an exterior surface of the object 102 in another manner. In some cases, the identity marker 104 is secured to the object 102 in a manner that prevents the identity marker 104 from being removed, so that the identity marker 104 may serve as a long term (e.g., permanent) identifier for the object 102.

In some implementations, the electrostatic printer system used for creating an identity marker 104 includes a toner cartridge containing a toner mixture, which includes a mixture of particles. In some examples, the toner mixture includes toner material and identity-forming particles. In some implementations, the toner material is a particulate material that includes fusible particles (e.g., polymer particles) and non-fusible particles (e.g., color pigment particles), which can be electrostatically controlled by the electrostatic printer system. The printing process fuses the fusible particles in the toner mixture to each other as they are bonded to the printing surface, which secures the identity-forming particles (e.g., diamond particles) and other non-fusible particles of the toner material. Consequently, the identity-forming particles in the toner mixture become secured at fixed locations within the fused material on the printing surface. After fusing, the fusible particles are no longer distinguishable from one another, and they form a supporting matrix for the embedded identity-forming and other non-fusible particles.

In some instances, the non-fusible particles in the toner mixture are mixed with the toner material to form the toner mixture with specified properties (e.g., a specified concentration and particle size distribution). For instance, the concentration and particle size distribution of the identity-forming particles in the toner mixture can affect the resolution and other properties of the printed image on the identity marker, which can impact the security level of the identity marker 104. In some implementations, identity-forming particles are diamond particles, which may be implemented as diamond microparticles or nanoparticles that include nitrogen vacancy centers or other naturally occurring point defects. In some instances, properties of the identity-forming particles in the identity marker (such as, e.g., location and orientation) can be detected and further used to determine the identity of the associated object 102. The identity marker 104 can include a printed image, and the identity-forming particles can be distributed in at least a part of the printed image.

In some implementations, the example identity marker 104 can be used as the unique markers described in PCT Pub. No. WO2017/155967A1. For instance, a unique set of properties of the identity-forming particles in the identity marker 104 can be used to generate a unique code, which can be used for authentication, tamper detection, or other purposes.

In some implementations, an identity-forming particle has a finite extent, a measurable spatial location on a surface, and geometric properties that can be used to determine orientations with respect to a coordinate system. For example, an identity-forming particle may have a geometry bearing a non-zero second moment of inertia (e.g., a rod or a cylinder) which results in an orientation relative to a point, such as its center of mass. In some instances, an identity-forming particle may have other geometries or symmetries (e.g., a cone or a pyramid).

In some implementations, identity-forming particles have other properties which can be used to determine orientations with respect to a coordinate system. For example, NV-color center point defects in single crystalline diamonds exist at specific relative orientations within the underlying lattice. Properties of such defects of diamond particles, for example magnetic resonance frequencies under an external magnetic field, can be used to determine the orientation of the diamond lattice with respect to the external magnetic field. For another example, metallic (e.g., gold) nanorods exhibit strong surface plasmon resonances that give rise to strong anisotropic polarizability. This polarizability can be used to determine the orientation of the metallic nanorod with respect to an incident electromagnetic field. For another example, photonic structures patterned onto particles in dielectric materials can also exhibit resonances based on the relative coupling of electromagnetic waves to the modes of the photonic structure. The relative intensities of reflected light can reveal the orientation of the photonic structure relative to the direction of the incident light.

In some implementations, a unique set of features provided by the identity-forming particles in the identity marker 104 can be identified using an imaging system or another type of scanner system. For example, the identity marker 104 may be scanned by a fluorescence microscope that detects fluorescence properties of the identity-forming particles, a nuclear magnetic resonance (NMR) spectrometer that detects spin properties of the identity-forming particles, or another technique. In some cases, batch-level or brand-level information can be extracted. For example, a diamond material formulation could have specifically engineered properties, like the brightness of the fluorescence or a particle size distribution, such that this formulation alone, independent of the spatial and orientation of the particle array, may indicate a particular batch.

FIG. 1B is a schematic diagram showing aspects of an example system 120. The example system 120 includes a mixer system 124, a printer system 126, and a scanner system 128, which are communicably coupled to a computer system 122. In some instances, the example system 120 can be used to form a toner mixture, print an identity marker using the toner mixture, to determine an identifier of the identity marker, or to perform a combination of these and possibly other functions. In some implementations, the system 120 may include additional and different features or components, and components of the example system 120 may be implemented in another manner.

The example mixer system 124 shown in FIG. 1B is configured to mix identity-forming particles (e.g., uniformly or otherwise) with a toner material to form a toner mixture. In some implementations, the identity-forming particles include diamond particles. In some instances, the mixer system 124 is configured to select diamond particles and the toner material according to instructions or specifications received from the computer system 122, from a user 130 or from another source. In some implementations, the mixer system 124 selects diamond particles according to a target size distribution and mixes the selected diamond particles with toner particles of the toner material at a predetermined weight percentage. In some implementations, the weight percentage is determined according to a composition of the toner particles in the toner material, the target size distribution of the diamond particles, a type of substrate material that the toner mixture is printed on, and possibly other parameters. In some implementations the target size distribution may be narrow, for example, specifying a mean particle size and little variation of that size to the mean (e.g., unimodal). In other implementations, the distribution may be a combination of several unimodal distributions (e.g., multimodal). Furthermore, the distributions may be quite broad, spanning orders of magnitude in size variation.

In some implementations, the toner particles in the toner material include non-fusible particles embedded in a binder resin. The non-fusible particles may include color pigment particles, charge control particles, or other types of particles. In some instances, the toner material includes both fusible particles (e.g., binder resin and wax particles) and non-fusible particles (e.g., color pigment particles). In certain instances, the surfaces of the toner particles are treated with external additives to improve toner flow, adhesion, stability, and tribocharging properties. In some instances, a toner particle may have a size in a range of 1-20 micrometers (μm) and the non-fusile particles within a toner particle may have a size in a range of 100 to several hundreds of nanometers (nm) in diameter. In some implementations, the size distribution of the identity-forming particles is in a range of 100 nanometers to 200 micrometers in diameter.

In some instances, the mixer system 124 may include a paint shaker, a rotation cylinder, a blender, or another type of mixing apparatus. In some instances, during mixing of the selected identity-forming particles with the toner particles, by operation of the mixer system 124, electrostatic charge exchange may occur between the identity-forming particles and the toner particles. In this case, the toner particles and the identity-forming particles may become electrostatically charged and adhere to each other. In some instances, multiple identity-forming particles can electrostatically bond to a single toner particle, for example, when the identity-forming particles are significantly smaller in size than the toner particles. In certain instances, multiple toner particles may electrostatically bond to a single identity-forming particle, for example, when the identity-forming particles are significantly greater in size than the toner particles. In these cases, the flow of the identity-forming particles is controlled by toner particles which function as carrier particles. In certain instances, surfaces of the identity-forming particles can be separately treated to improve tribocharging properties.

In some implementations, the printer system 126 is an electrostatic printer system, which can be implemented as the example electrostatic printer system 200 shown in FIG. 2A or in another manner. The printer system 126 is configured to receive the toner mixture from the mixer system 124 in a toner cartridge, receive the design of the identity marker from the computer system 122, and transfer the toner mixture including the identity-forming particles on to a substrate. The printer system 126 can affix the identity-forming particles to the substrate, for example, by securing them at fixed locations in a host matrix formed by fusing the toner material.

In some implementations, the scanner system 128 is configured to extract information about the identity-forming particles in the identity marker (e.g., to determine an identifier). For example, a scanner system 128 may extract a distribution of properties of the identity-forming particles in at least one area of the identity marker, which includes a subset of the identity-forming particles in the identity marker. For example, the scanner system 128 may extract information, such as a distribution of relative spatial orientations, a distribution of relative locations, a distribution of sizes and shapes, or other types of information, from an area of an identity marker. In some instances, the scanner system 128 can be configured to extract information from the identity marker, for example, by applying a stimulus to the identity marker and recording a response of the identity marker to the stimulus. For instance, the scanner system may include an illumination source (e.g., a laser or other light source), optical components (e.g., lenses, mirrors, filters, amplifiers, etc.), optical sensors, cameras (e.g., a CMOS camera, a CCD camera, or another type of camera), signal generators (e.g., RF signal generators, microwave signal generators, etc.), coils and antennas, magnet systems (e.g., an electromagnet, a superconducting magnet, etc.), and other components.

In I some implementations, the scanner system 128 may include a probe that can detect an optical response from an identity marker. In some instances, an optical response may include fluorescence response, Raman scattering, second harmonic generation, spontaneous parametric down conversion, or other types of optical response. In some implementations, the scanner system 128 may include a probe that can detect a magnetic response from an identity marker. In some instances, a magnetic response may include electron spin resonance (ESR), nuclear magnetic resonance (NMR), optically detected magnetic resonance (ODMR), or other types of magnetic response. In some implementations, the scanner system 128 may include another type of probe that can be used to detect properties of the identity-forming particles in an identity marker. For example, when an identity marker is formed, the scanner system 128 can be used to scan one or more areas of the identity marker to generate an identifier associated with the identity marker based on scanning data, which includes the detected properties.

In the example shown in FIG. 1B, the computer system 122 includes a processor 132, memory 134, a communication interface 140, a display device 142, and an input device 144. In some implementations, the computer system 122 may include additional components, such as, for example, input/output controllers, communication links, power source, etc. In some instances, the computer system 122 may be configured to control operational parameters of the mixer system 124, the printer system 126, and the scanner system 128; to receive instructions from the user 130 or an external system; and to receive scanning data from the scanner system 128.

In particular, the computer system 122 may receive specifications including a design of an identity marker 104, a security level of the identity marker 104, and other parameters of the identity marker 104 (e.g., resolution, color, etc.). The computer system 122 can then translate the design parameters and other specifications to operational parameters of the mixing, printing, and scanning processes performed in the mixer system 124, the printer system 126, and the scanner system 128. For example, a target size distribution and a weight percentage of the identity-forming particles in a toner mixture according to the inputs may be determined by the computer system 122 and transmitted to the mixer system 124 for forming the toner mixture. For another example, a toner material including fusible particles and non-fusible particles that are compatible with the selected identity-forming particles may be also determined by the computer system 122. In some instances, the toner mixture can be pre-formed and the computer system 122 can select a particular toner mixture (e.g., with a particular size distribution of the identity-forming particles, a particular weight percentage, a particular composition of the toner particles, etc.) according to the received instructions or specifications.

In some cases, the computer system 122 may also determine printing parameters that are compatible with the selected identity-forming particles, and the printer system 126 can use the printing parameters to create the identity marker 104. For example, a printing resolution, a clearance gap between a doctor blade of a toner compartment or a wiper blade of a waste collection reservoir and an image transfer drum, a charge level of the image transfer drum 202, a heating temperature and time in a fuser assembly, and other printing parameters can be adjusted to specified values according to properties of the toner mixture or other factors.

In some cases, the computer system 122 may also determine the scanning parameters according to the identity-forming particles in the identity marker 104. For example, the computer system 122 may determine scanning resolution, type of scanner in the scanner system 128, and other scanning parameters according to the selected identity-forming particles and the design of the identity marker. In some implementations, the computer system 122 is configured to generate an identifier based on scanning data containing detected properties received from the scanner system 128 and to associate the identifier with the identity marker 104. In some implementations, the computer system 122 may be configured to perform other operations.

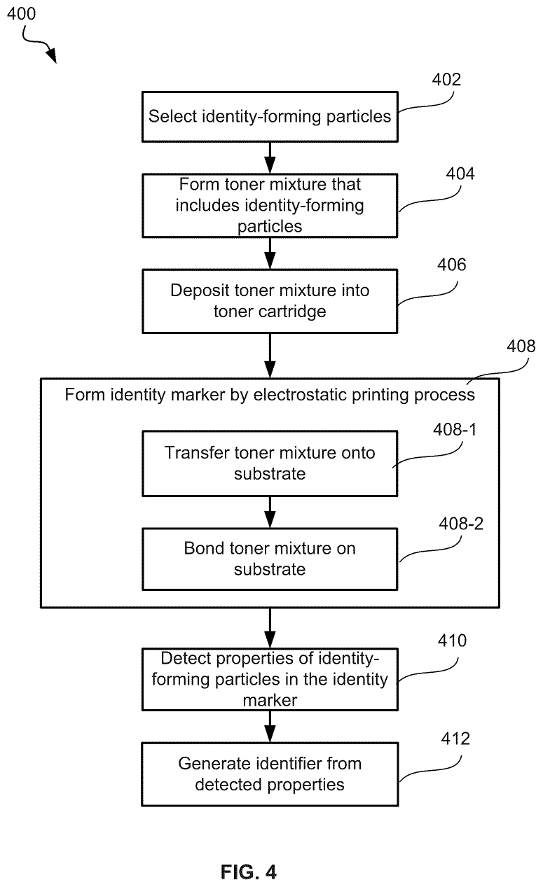

In some implementations, the computer system 122 may be used to implement one or more aspects of the systems and processes described with respect to FIGS. 2A, 2B, and 4, or to perform other types of operations. In some implementations, the computer system 122 includes separate control units associated with, and providing specific control functions to, the mixer system 124, the printer system 126, and the scanner system 128.

In some implementations, the computer system 122 may include a single computing device, or multiple computers that may communicate with the mixer system 124, the printer system 126, the scanner system 128, and the user 130 via the communication interface 140 through a communication network, e.g., a local area network (LAN), a wide area network (WAN), an inter-network (e.g., the Internet), a network comprising a satellite link, and peer-to-peer networks (e.g., ad hoc peer-to-peer networks).

In some implementations, some of the processes and logic flows described in this specification can be automatically performed by one or more programmable processors, e.g. processor 132, executing one or more computer programs to perform actions by operating on input data and generating output. For example, the processor 132 can run the programs 136 by executing or interpreting scripts, functions, executables, or other modules contained in the programs 136. In some implementations, the processor 132 may perform one or more of the operations described, for example, with respect to FIG. 4.

In some implementations, the processor 132 can include various kinds of apparatus, devices, and machines for processing data, including, by way of example, a programmable data processor, a system on a chip, or multiple ones, or combinations, of the foregoing. In certain instances, the processor 132 may include special purpose logic circuitry, e.g., a microcontroller, a programmable logic controller, an FPGA (field programmable gate array), an ASIC (application specific integrated circuit), or a Graphics Processing Unit (GPU) for running the artificial intelligence (AI) algorithms. In some instances, the processor 120 may include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. In some examples, the processor 132 may include, by way of example, both general and special purpose microprocessors, and processors of any kind of digital computer.

In some implementations, the processor 132 may include both general and special purpose microprocessors. Generally, a processor 132 receives instructions and data from a read-only memory or a random-access memory or both, e.g. memory 134. In some implementations, the memory 134 may include all forms of non-volatile memory, media, and memory devices, including by way of example semiconductor memory devices (e.g., EPROM, EEPROM, flash memory devices, and others), magnetic disks (e.g., internal hard disks, removable disks, and others), magneto optical disks, and CD ROM and DVD-ROM disks. In some cases, the processor 132 and the memory 134 can be supplemented by, or incorporated in, special purpose logic circuitry.

In some implementations, the data 138 stored in the memory 134 may include operational parameters (e.g., mixing parameters, printing parameters, and scanning parameters), a reference database (e.g., design of an identity marker and one or more associated identifiers), and possibly other types of data. In some implementations, the programs 136 can include software applications, scripts, programs, functions, executables, or other modules that are interpreted or executed by the processor 132. In some implementations, the programs 136 may include machine-readable instructions for identification of identity markers based on detected data received from the scanner system 128. In some instances, the programs 136 may include machine-readable instructions. In some instances, the programs 136 may obtain input data from the scanner system 128 or the user 130, from another local source, or from one or more remote sources (e.g., via a communication link). In some instances, the programs 136 may generate output data (e.g., one or more identifier) and store the output data in the memory 134, in another local medium, or in one or more remote devices. In some examples, the programs 136 (also known as, software, software applications, scripts, or codes) can be written in any form of programming language, including compiled or interpreted languages, declarative or procedural languages. In some implementations, the programs 136 can be deployed to be executed on the computer system 122.

In some implementations, the communication interface 140 can be connected to a communication network, which may include any type of communication channel, connector, data communication network, or other link. In some instances, the communication interface 140 may provide communication with other systems or devices. In some instances, the communication interface 140 may include a wireless communication interface that provides wireless communication under various wireless protocols, such as, for example, Bluetooth, Wi-Fi, Near Field Communication (NFC), GSM voice calls, SMS, EMS, or MMS messaging, wireless standards (e.g., CDMA, TDMA, PDC, WCDMA, CDMA2000, GPRS) among others. In some examples, such communication may occur, for example, through a radio-frequency transceiver or another type of component. In some instances, the communication interface 140 may include a wired communication interface (e.g., USB, Ethernet) that can be connected to one or more input/output devices, such as, for example, a keyboard, a pointing device, a scanner, or a networking device such as a switch or router, for example, through a network adapter.

In some implementations, the communication interface 140 can be coupled to input devices and output devices (e.g., the display device 142, the input device 144, or other devices) and to one or more communication links. In the example shown, the display device 142 is a computer monitor for displaying information to the user or another type of display device. In some implementations, the input device 144 is a keyboard, a pointing device (e.g., a mouse, a trackball, a tablet, and a touch sensitive screen), or another type of input device, by which the user 130 can provide input to the computer system 122. In some examples, the computer system 122 may include other types of input devices, output devices, or both (e.g., mouse, touchpad, touchscreen, microphone, motion sensors, etc.). The input devices and output devices can receive and transmit data in analog or digital form over communication links such as a wired link (e.g., USB, etc.), a wireless link (e.g., Bluetooth, NFC, infrared, radio frequency, or others), or another type of link.

FIG. 2A is a schematic diagram of an example electrostatic printer system 200. As shown in FIG. 2A, the example electrostatic printer system 200 includes a toner cartridge 208 and a fuser assembly 212. The toner cartridge 208 includes an image transfer drum 202, a charge leveling source 204, an optical image source 206, a toner compartment 220, and a waste collection reservoir 210. In some implementations, the example electrostatic printer system 200 may include additional and different features or components and components of the example electrostatic printer system 200 may be implemented in another manner. An image representing the design of an identity marker (which may generally include, e.g., any combination of graphics, texts, and images) can be communicated to the example electrostatic printer system 200 (e.g., from the computer system 122 in FIG. 1B), which prints the image on a substrate to form the identity marker. In some implementations, an identity marker formed by the example electrostatic printer system 200 includes identity-forming particles (e.g., diamond particles or other types of identity-forming particles). For instance, the image may be formed from a toner mixture that includes diamond particles. In some instances, a distribution of properties of the diamond particles in the identity marker can be used for identification and authentication purposes.

The example image transfer drum 202 transfers a toner mixture containing toner particles from the toner compartment 220 to the substrate 220. In the example shown in FIG. 2A, an outer surface of the image transfer drum 202 is photosensitive and holds electrostatic charge. In some instances, the outer surface of the image transfer drum 202 has a generally cylindrical shape and a multi-layer structure (e.g., a photo-charging layer, a charge leakage barrier layer, and a surface layer). During operation, the outer surface of the image transfer drum 202 is charged by the charge leveling source 204, so that the image transfer drum 202 can attract and hold the oppositely-charged particles in the toner mixture. The toner particles are held to the outer surface of the image transfer drum 202 by the electrostatic force, and the image transfer drum 202 then deposits the toner particles onto the substrate 220.

In some implementations, the optical image source 206 includes a light source that forms a light beam in the electrostatic printer system 200. In the example shown, image information is transmitted to the image transfer drum 202 as an optical signal. For example, the optical image source 206 can be a laser source that generates a laser beam. In this case, the laser beam can be directed through a system of lenses and mirrors onto the surface of the image transfer drum 202. As another example, the optical image source 206 can be implemented as an array of light-emitting diodes (LEDs) spanning the width of the image transfer drum 202 to generate an electrostatically charged pattern on the surface of the image transfer drum 202.

In some aspects of the operation, the image transfer drum 202 rotates (in the clockwise direction, as shown in FIG. 2A). While rotating, the outer surface of the image transfer drum 202 becomes charged (e.g., positively charged) by the charge leveling source 204. After becoming charged, the surface of the image transfer drum 202 is illuminated by the light beam from the optical image source 206. Regions of the surface of the image transfer drum 202 that are struck by the light beam become electrically neutralized or reversed. Consequently, the illumination shapes the region of the image transfer drum 202 that is positively charged, leaving a static electric positive image on the surface of the image transfer drum 202. In other words, an optical image is cast onto the surface of the image transfer drum 202, which records an inverse image of electrostatically charged regions (e.g., positively charged surface regions) on the surface. The positively charged surface regions of the image transfer drum 202 can electrostatically attract negatively charged toner particles from the toner compartment 220.

In the example shown in FIG. 2A, the particles in the toner mixture from the toner compartment 220 becomes negatively charged. The negatively charged particles are coated on the surface of a developer roller 214A of the toner compartment 220 and pressed against the surface of the image transfer drum 202. The negatively charged particles are pulled to the positively charged surface regions of the image transfer drum 202 by electrostatic forces, which forms shaped regions of a toner mixture on the surface of the image transfer drum 202.

In some implementations, the toner compartment 220 includes a doctor blade 222 that can be used to apply triboelectric charges to the passing particles. Optimization of this component through improvements in materials of construction (e.g., metal alloys, filled polymers, or other materials) and abrasion-resistant coatings can improve the charge transfer performance of the identity-forming particles in the toner mixture, which can improve downstream image transfer. In this case, the toner particles and the identity-forming particles can be negatively charged by the doctor blade 222 of the toner compartment 220.

To transfer the electrostatically attracted toner mixture on the surface of the image transfer drum 202 to the surface of the substrate 220, a roller 214B is configured to apply pressure to the substrate 220 and the surface of the image transfer drum 202. In some instances, the surface of the substrate 220 can be more positively charged than the surface of the image transfer drum 202 to effectively pull the negatively charged toner particles and identity-forming particles from the surface of the image transfer drum 202 to the surface of the substrate 220 to deposit the toner mixture onto the substrate 220.

The example fuser assembly 212 includes a heat source and one or more rollers 216A, 216B. The heat source is configured to heat the substrate 220, and the rollers 216A, 216B are configured to apply pressure to the toner mixture and the substrate 220. Fusible particles in the toner mixture on the substrate 220 are melted by the heat source so as to permanently bond the identity-forming particles (e.g., diamond particles) and other non-fusible particles to the surface of the substrate 220. In some instances, the heat source may include a radiant heat lamp, or another type of heat source. For example, a first roller 216A can be hollow and the heat source can reside in the first roller 216A to uniformly heat the first roller 216A. In some instances, a second roller 216B is a pressure roller arranged transversely across the width of the substrate 220. The identity-forming particles and other non-fusible particles in the transferred toner are fixed in the image on the substrate 220 by fusing the fusible particles. Upon fusing, the fusible particles are no longer distinguishable from one another, and the identity-forming particles (e.g., the diamond particles) remain distinguishable at fixed locations in the image affixed to the substrate 220.

In some implementations, the waste collection reservoir 210 is configured to collect residual toner materials from the surface of the image transfer drum 202 that are not transferred to the surface of the substrate 220. In some instances, the waste collection reservoir 210 includes an electrically neutral, replaceable doctor blade extending across the width of, and adjacent to, the surface of the image transfer drum 202 to clean the surface of the image transfer drum 202. After cleaning, the surface of the image transfer drum 202 is again positively charged by the charge leveling source 204, illuminated by the optical image source 206, and the process continues in a cyclical manner as the image transfer drum 202 rotates.

Diamonds are known for their extreme hardness, which may translate to accelerated wear and tear on internal printer components. Typically, the surface of the image transfer drum 202 and the doctor blades are the primary objects of wear in an electrophotographic printer. To compensate for the increased abrasion from diamond particles, the image transfer drum and doctor blade may be coated with abrasion-resistant coatings, such as silsesquioxane, diamond-like carbon, amorphous silicon, or ternary transition metal nitrides, e.g., AlZrN. In addition, the outer charge transfer layer of the image transfer drum 202 and the doctor blade may be impregnated with fillers to reduce wear. Examples of fillers include resin powders, carbon powders, metal powders, and metal oxides.

In the example shown in FIG. 2A, the image printed on the substrate 220 contains an ensemble of identity-forming particles whose position and orientation are randomly distributed, and the image can function as an identity marker. For example, a unique, unclonable identity may be defined from the spatial and orientation configuration of the identity-forming particles that are embedded in the image on the surface of the substrate 220. Certain aspects of the identity marker can be controlled or specified, for example, by the properties of the toner mixture in the toner compartment 220.

In some implementations, the toner mixture in the toner compartment 220 is a uniformly blended mixture of particles made of various materials for different purposes. For example, a mixture of particles in a toner cartridge may include binders, pigments, flow agents, charge control agents, and particles for other purposes. In some instances, a mixture of particles in the toner compartment 220 includes polymers, copolymers, metal oxides, silica, carbon black, and other materials in a low-shear mixer until homogenously dispensed. In some instances, a mixture of particles in the toner compartment 220 includes a mixture of fusible particles (e.g., polymer particles) and non-fusible particles (including identity-forming particles). In certain implementations, the toner mixture is prepared by blending diamond particles (or other identity-forming particles) with the fusible toner particles and possibly other materials. In some instances, a toner mixture can be prepared by mixing diamond particles (or other identity-forming particles) with a toner material (e.g., containing pre-made toner particles) using a mixer system (e.g., the mixer system 124 of FIG. 1B) or in another manner.

In some implementations, to improve the electrostatic transfer performance, identity-forming particles could be surface modified to improve toner properties (e.g., flowability, charge carrying capacity, etc.). When the identity-forming particles are diamond particles, each diamond particle includes a diamond cage at its core, which is composed mainly of carbon atoms and has a structure of a diamond, e.g., face-centered cubic with tetrahedral holes filled with four atoms. In some instances, the surface of each diamond nanoparticle has a structure of graphite. For example, the surface of diamond particles includes carbons, with high amounts of phenols, pyrones, and sulfonic acid, as well as other functional groups, including carboxylic acid groups, hydroxyl groups, epoxide groups, and other types of functional groups. The surface of the diamond particles can be modified through means such as covalent functionalization (e.g., silanization), non-covalent functionalization (e.g., PEGylation), or physical coating (such as polymer resin). Such surface modification of diamonds may be performed prior to toner mixing and is not adversely affected by the fuser processes.

In some implementations, an identity-forming particle based on a diamond particle includes one or more color centers. In some instances, a color center in a diamond particle can be a nitrogen vacancy center, where a carbon atom of the lattice is replaced with a nitrogen atom and a nearest neighbor carbon atom to that nitrogen atom being removed entirely. In some instances, the orientation of the color center may be defined, for example, by a vector directed from the nitrogen atom to the vacancy. In some instances, the symmetry of the lattice and four-fold symmetry of an NV center may preclude absolute knowledge of the crystal orientation, and the relative orientation of two centers may be known with two-fold symmetry. The nitrogen atom and vacancy within the carbon lattice of a diamond particle define a directional vector with a distinct orientation with respect to the crystal lattice coordinate axes. In some implementations, information of at least a subset of diamond particles in the identity marker printed using the example system 200, for example, orientation information of the one or more color centers in a subset of diamond particles, may be used for identification of an associated object, security, and authentication purposes.

In some implementations, a size distribution of the diamond particles in the toner compartment 220 is controlled to achieve specified properties of the identity marker. In some instances, the diamond particles in the toner mixture have diameters in a range of 100 nanometers (nm)-200 micrometers.

In some implementations, the concentration of diamond particles in the toner compartment 220 is controlled to achieve specified properties of the identity marker. In some examples, a weight percentage of diamond particles in a toner mixture can be less than 25%. This concentration range can produce covert identity markers that are not immediately discernible to casual observers. In some examples, a weight percentage of diamond particles in a toner mixture can be greater than 25%, but less than 75%. This concentration range is ideal for producing identity markers that compromise between security and appearance, providing a large serialization space while maintaining a discreet appearance. In certain examples, a diamond concentration in excess of 75% may allow for the application of identity markers with a high particle density, which may impart the deposited layer with physical properties of the diamond particles (e.g., high thermal conductivity, low electrical conductivity, and optical reflection and scattering). In this case, identity markers using a toner containing high concentration of diamond particles are also more overt than the identity markers created using low concentration of diamond particles (e.g., <75%) and can be used to create high-visibility identity markers for decoration or branding. In some implementations, the sizes of the diamond particles also determine the properties of identity markers created using the example system 200.

In some implementations, diamond particles with multiple distinct, size distributions, concentrations, or electromagnetic attributes (e.g. fluorescence, phosphorescence, NV-center concentration, etc.) can be incorporated together into a toner mixture. The example electrostatic printer system 200 can be used to create multiple unique, unclonable identity markers or identity markers that can be authenticated through multiple interrogation techniques (e.g., for example using the scanner system 128 in FIG. 1B). Furthermore, secondary attributes of identity markers (such as particle size) can also be associated with batches or points of origin, offering additional mechanisms for authentication.

In some implementations, clearances between doctor blades and the surface of the image transfer drum 202 in the example system 200 can be tuned (e.g., mechanically adjusted) according to the size of the identity-forming particles in the toner compartment 220. For example, when large identity-forming particles are used (>100 micrometer in diameter) in the toner compartment 220, the clearances in the examples system 200 can be increased to allow for the larger identity-forming particles to be transferred on to the surface of the image transfer drum 202 and finally deposited on the surface of the substrate 220.

In some implementations, an identity marker on the surface of the substrate 220 includes multiple layers of the transferred toner. Each layer can include one or more elements that can function as an identity marker. In this case, identity-forming particles can be selectively included in one or more layers. In some instances, multiple layers of the transferred toner with proper registration can be formed in a single pass of the substrate 220 through the example electrostatic printer system 200. In some implementations, the example electrostatic printer system 200 is a multi-channel printer system. For example, identity-forming particles can be loaded into one or more toner cartridges in the multi-channel printer system. In some instances, a first printed layer may transfer a design (photo, illustration, text, etc.) using a first toner cartridge that contains toner material without identity-forming particles. A second printed layer may use a second toner cartridge that contains a toner mixture that includes identity-forming particles. The second printed layer may be selectively printed on the substrate either on the first layer or directly on the surface of the substrate to create an identity marker. In certain instances, a third printed layer may use a clear gloss toner for coating the first and second printed layers to enhance the appearance and durability of the underlying printed layers. In some instances, identity-forming particles with multiple distinct size ranges, concentrations, or electromagnetic attributes can be incorporated into separate parallel printer channels (e.g., different toner cartridges) to selectively print one or more types of unique, unclonable identity markers at a time. In some instances, different printer channels may include different types of identity-forming particles (e.g., diamond particles, metal particles, photonic nanocrystals, etc.).

FIG. 2B is a schematic diagram of an example electrostatic printer system 230. The example electrostatic printer system 230 is a multi-channel printer system which includes multiple toner cartridges and can be used for forming identity markers with multiple layers on a substrate during a single pass. As shown in FIG. 2B, the example electrostatic printer system 230 includes an array of five toner cartridges 232 (e.g., 232A, 232B, 232C, 232D, and 232E) and a fuser assembly 238. In some instances, each of the toner cartridges 232 in the array may be implemented as the toner cartridge 208 in FIG. 2A or in another manner. As shown in FIG. 2B, the array of toner cartridges 232 reside above an image transfer belt 234. In some implementations, the example electrostatic printer system 230 may include additional and different features or components and components of the example electrostatic printer system 230 may be implemented in another manner.

During operation, an image representing the design of an identity marker (which may include, e.g., any combination of graphics, texts, and images) can be communicated to the example electrostatic printer system 230 (e.g., from the computer system 122 in FIG. 1B). Each toner cartridge 232 prints a layer on the image transfer belt 234. A final image with multiple layers on the image transfer belt 234 is transferred on a substrate 240 to form the identity marker. In some implementations, an identity marker formed by the example electrostatic printer system 230 includes identity-forming particles (e.g., diamond particles or other types of identity-forming particles). In some instances, a distribution of properties of the identity-forming particles in the identity marker can be used for identification and authentication purposes.

In some instances, the surface of the image transfer belt 234 can be charged to receive multiple layers of images from the toner cartridges 232. For example, a first layer can be formed on the image transfer belt 234 using a first toner cartridge 232A. The first layer on the image transfer belt 234 is then transferred from a first position (e.g., at the first toner cartridge 232A) to a second position (e.g., at a second toner cartridge 232B). A second layer can be formed on the image transfer belt 234 using the second toner cartridge 232B. In some instances, the second layer may be aligned on top of the first layer, formed on the image transfer belt 234 partially covering the first layer, or at a location distinct from the first layer. Similarly, when an identity marker includes more than two layers, additional layers can be further formed on the image transfer belt 234 using additional toner cartridges 232 in the example system 230.

In some implementations, the toner cartridges 232 in the example system 230 contain different toner mixtures. For example, the toner cartridge 232A may include diamond particles; the toner cartridges 232B, 232C, 232D may include color pigment particles for producing graphical details; and the toner cartridge 232E may include a toner mixture for producing a background for the identity marker. In some examples, the toner cartridge 232A includes a toner mixture for provide a top-layer coating, e.g., a clear laminate layer. In this case, a toner mixture with diamond particles can be loaded into one or more of the toner cartridges 232B, 232C, 232D, or 232E.

After the identity marker with multiple layers is formed on the image transfer belt 234, the identity marker is then transferred onto the substrate 240 with the order of the layers reversed. In order to improve the image transfer behavior, modifications to the content of the toner mixture, the mixing process, or the print mechanism (e.g., ultrasonic ejection) can be made. In certain instances, the identity marker on the substrate 240 can be further transferred to a surface of a final product (e.g., textiles, mugs, or branded merchandise) using techniques such as heat transfer, heat pressing, heat embossing, pressure transfer, or another technique.

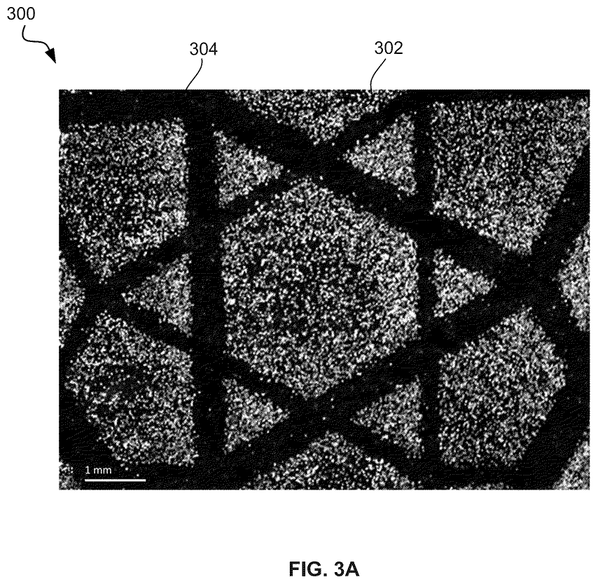

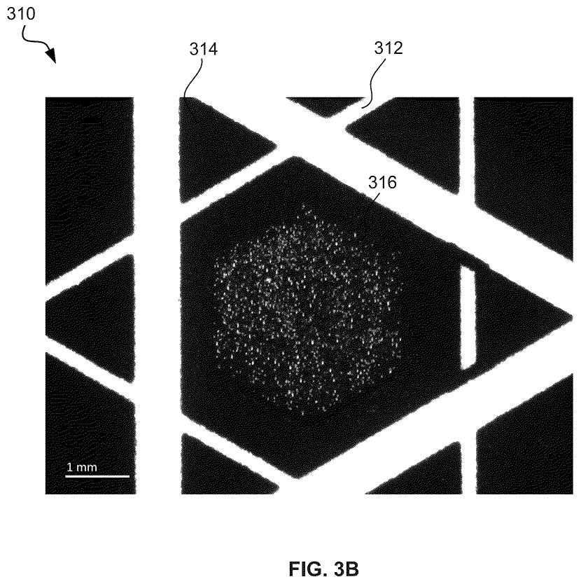

FIG. 3A is a microscopic reflected-light optical image showing aspects of an example identity marker 300 created by an electrostatic printing process. The example identity marker 300 is produced by a single-channel electrostatic printer system, e.g., the example system 200 shown in FIG. 2A. A black background 304 is initially prepared on a copy paper by passing the copy paper through the single-channel electrostatic printer system with a monochrome black toner. A toner mixture is prepared by homogeneously blending diamond particles in a size range of 1-100 μm with clear toner at a loading of 30-60% by weight with low shear in a closed container, which is then loaded into an empty toner compartment in a toner cartridge. The toner cartridge containing the diamond particles is then loaded into the single-channel electrostatic printer system. The copy paper with the black background is then passed through the single-channel electrostatic printer system again, while a second layer 302 is printed over the black background 304 to produce the identity marker 300.

FIG. 3B is a microscopic reflected-light optical image showing aspects of an example identity marker 310 created by an electrostatic printing process. The example identity marker 310 is produced by a multi-channel electrostatic printer system, e.g., the example system 230 shown in FIG. 2B.

FIG. 4 is a flow chart showing aspects of an example process 400 for producing an identity marker. Certain operations in the example process 400 can be performed by an electrostatic printing system such as, the example system 120 shown in FIG. 1B. The example process 400 may include additional or different operations, including operations performed by additional or different components, and the operations may be performed in the order shown or in another order. In some cases, operations in the example process 400 can be combined, iterated or otherwise repeated, or performed in another manner.

At 402, identity-forming particles are selected. In some implementations, identity-forming particles are selected according to the design parameters of the identity marker. In some instances, design parameters of an identity marker can be received by a computer system. For example, design parameters may include size and color of the identity marker, a type of substrate that the identity marker is printed on, a type of the scanner system used for interrogating the identity marker, a security level of the identity marker, or a combination of these and other design parameters. In some instances, the computer system may determine a size distribution, a weight percentage range, a surface functionalization, and other properties of the identity-forming particles and the selected identity-forming particles that are used to form a toner mixture for electrostatic printing of an identity marker.

At 404, the toner mixture is formed. A toner mixture includes a mixture (e.g., a homogeneous and uniform mixture) of the selected identity-forming particles and a toner material. In some implementations, prior to forming the toner mixture, a toner material containing toner particles is selected. In some instances, the toner material can be determined and selected according to the design of the identity marker (e.g., color, resolution, etc.). For example, the type of color pigment in the toner material, the size distribution of the toner particles in the toner material, and surface additives of the toner particles in the toner material can be selected to be compatible with the selected identity-forming particles for forming the identity marker. In some instances, the selected identity-forming particles and toner particles are mixed using a mixer system (e.g., the mixer system 124 in FIG. 1B). In some instances, mixing parameters (e.g., time, temperature, speed, etc.) used by the mixer system when forming the toner mixture, can be also determined, e.g., by the computer system 122 in FIG. 1B, according to the selected identity-forming particles and toner particles.

At 406, the formed toner mixture is incorporated into a toner cartridge. In some implementations, the toner cartridge is a toner cartridge used in a printer system (e.g., the printer system 126 in FIG. 1B).

At 408, the identity marker is formed by performing an electrostatic printing process. In some implementations, the identity marker is formed on the surface of a substrate using a printer system. In some implementations, the identity marker includes identity-forming particles and each identity-forming particle in the identity marker has a structure (internal or external) that defines an orientation of the identity-forming particle. When, the identity-forming particles include diamond particles, a symmetry axis, a nitrogen vacancy axis, or a plane of an internal feature or structure of a diamond particle can be used to define an orientation of the diamond particle. In some implementations, an image representing the design of an identity marker can be communicated to the printer system. The image of the identity marker is formed on the surface of the substrate using the toner mixture in the toner cartridge of the printer system. In some implementations, the printer system can be implemented as the example electrostatic printer system 200 described in FIG. 2A or in another manner.

Operation 408 includes two sub-operations 408-1 and 408-2. At 408-1, the toner mixture is transferred onto the substrate. In some implementations, an image transfer drum of the printer system can transfer the toner mixture from the toner cartridge to the substrate. In some instances, the surface of the image transfer drum can be charged, e.g., by the charge leveling source 204, and then patterned, e.g., by the optical image source 206 in FIG. 2A. As a result, an electrostatically positive image can be formed on the surface of the image transfer drum of the printer system. The positively charged surface regions of the image transfer drum can electrostatically attract negatively charged particles (e.g., negatively charged toner particles and negatively charged identity-forming particles) from the toner cartridge. The negatively charged particles are pulled to the positively charged surface regions of the image transfer drum by electrostatic forces, which forms shaped regions of attracted toner on the surface of the image transfer drum. The particles at the shaped regions on the surface of the image transfer drum are then transferred to the surface of the substrate, for example, by applying a pressure on the surface of the substrate so as to form transferred toner on the substrate. In some instances, the surface of the substrate can be positively charged to effectively pull the negatively charged particles from the surface of the image transfer drum to the surface of the substrate to form the transferred toner on the substrate.

At 408-2, the toner mixture is bonded to the substrate. In some implementations, the toner mixture is bonded to the substrate by applying heat and pressure using a fuser assembly (e.g., the fuser assembly 212 in FIG. 2A). Fusible particles (e.g., resin) of the toner particles can be melted and fused by the applied heat, thus forming a host matrix to hold the identity-forming particles and other non-fusible particles at fixed locations on the substrate. In some instances, residual toner, which is the portion of toner mixture that was not transferred from the image transfer drum to the substrate, can be collected from the surface of the image transfer drum so as to prepare the surface for further operation.

In some implementations, each identity-forming particle in the identity marker is fixed on the surface of the substrate relative to the other identity-forming particles on the same substrate. Relative locations and orientations of the identity-forming particles in an identity marker on a substrate remain fixed as long as the shape and structure of the substrate remains fixed. Accordingly, the identity marker may inherently define a distribution of element properties. The distribution of element properties may have thousands, millions, or more independent degrees of freedom that can vary in each object.

At 410, properties of the identity-forming particles in the identity marker are detected. The properties of the identity-forming particles in the identity marker can be extracted from the object, for example, by operation of a scanner system. The properties of the identity-forming particles in the identity marker can include, or can be based on, one or more of the following parameters, including information of the identity-forming particles in one or more areas of the identity marker. For instance, the information can describe a distribution of relative spatial orientations, a distribution of relative locations, a distribution of sizes and shapes, or combinations of these.

In some cases, the information of the identity-forming particles in the identity marker is extracted by imaging the identity marker using optical microscopy and processing the resulting images. In some cases, the element information is extracted by detecting magnetic resonance properties of the identity marker and processing the magnetic resonance data.

In some implementations, extracting the element information includes extracting orientation information from the identity marker, where the orientation information indicates relative spatial orientations of the respective elements of the identity marker. The orientation information can be formatted as a list, an array, or another format. In some cases, the orientation information includes coordinate transformations describing the relative spatial orientations of the respective elements. The coordinate transformations can be, for example, a list of transformation matrices, an order set of orthogonal rotations (such as a Euler decomposition) or coordinate transformations in another form. In examples where the elements are diamond particles, the orientation information can be a list of a composite transformation matrices (e.g., a composite transformation matrix for each diamond particle), and the list of composite transformation matrices can be invariant to global rotations of the coordinate system of the object.

In some cases, the element information (e.g., orientation information, location information, size information, shape information) is extracted by obtaining an optical response (e.g. a fluorescence response or another type of optical response) to illumination applied to the identity marker. The optical response may include Raman scattering or another nonlinear effect (e.g., second harmonic generation, spontaneous parametric down conversion, etc.) in some cases. In some examples, a fluorescence response can include electromagnetic signals, for example, in the range of 635 nm-800 nm or another wavelength, produced by a color center or another feature of an element (e.g., stokes and anti-stokes shifts or another nonlinear process). Fluorescence images of the object can be generated based on the fluorescence responses of the elements, and the relative spatial orientations can be determined from the fluorescence images. The orientation information may be determined based on fluorescence changes in the object, for example, fluorescence changes of the elements detected in response to changes in the illumination or changes in a field applied to the object. In another example, the orientation information can be determined based on the orientation dependence of a nonlinear optical process (e.g., second harmonic generation (SHG)).

In some cases, the element information (e.g., magnetic environment information) is extracted using magnetic resonance techniques such as, for example, electron spin resonance (ESR), nuclear magnetic resonance (NMR), optically detected magnetic resonance (ODMR), or another type of magnetic resonance technique. For example, a scanner can obtain a magnetic resonance response to an oscillatory electromagnetic field (e.g., radio frequency, microwave frequency, etc.) applied to the object, and a computer system can determine the relative spatial locations or orientations by analyzing the magnetic resonance responses. The magnetic resonance response can be obtained, for example, by positioning the object in an external magnetic field (e.g., a static external field), applying the oscillatory electromagnetic field (e.g., applying radio or microwave frequency pulses) to the object in the external magnetic field, and optically detecting magnetic resonance changes of the elements in response to relative changes in the external magnetic field (e.g., relative changes in the strength or orientation of the external magnetic field), relative changes in the oscillatory electromagnetic field (e.g., relative changes in the amplitude, frequency, or phase the oscillatory electromagnetic field).

In some implementations, the element information can be extracted independent of registering the object, for example, relative to the scanner system. In some cases, the object does not include registration markings or orientation references other than the elements themselves. When the element information is extracted by applying illumination to the identity marker, the orientations of the identity-forming particles can be described relative to each other, without reference to the angle of illumination. Similarly, when the element information is extracted by magnetic resonance techniques, the properties of the elements can be described relative to each other, without reference to the angle of an applied magnetic field. Accordingly, the element information can be invariant to global rotations of the coordinate system of the object.

In some implementations, when the identity-forming particles include diamond particles, the element information can be extracted by detecting relative orientations of the color centers in the diamond particles with respect to one another. Relative locations and orientations can be detected, in some cases, by processing fluorescence images, magnetic resonance data, or other measurements of the object. For example, the relative orientations can be identified using coordinate transformations, for instance, a composite transformation matrix that represents multiple transformations for each diamond particle. A composite transformation matrix for a diamond particle can represent a first transformation between a coordinate system of the object and a coordinate system of the diamond particle, and a second transformation between the coordinate system of the diamond particle and a coordinate system of a color center in the diamond particle. In some examples, each diamond particle includes a single color center (e.g., each individual diamond particle contains a single NV center). In some examples, some or all of the diamond particles include multiple color centers (e.g., each individual diamond particle contains two or more NV centers). When a single diamond particle includes multiple NV centers, the four-fold symmetry of the diamond lattice means that any of the four orientations can be chosen as a reference to describe the orientation of the particle.

In some implementations, extracting the element information includes extracting location information from the object, where the location information indicates relative spatial positions of the respective elements of the object. The location information can be formatted as a list, an array, or another format. In some cases, the location information includes a list of coordinate vectors describing the relative spatial positions of the respective elements. Relative locations can be detected, in some cases, by processing fluorescence images, magnetic resonance data, or other measurements of the object.

In some cases, the element information of the identity-forming particles extracted at 410 indicate properties of only a subset of the identity-forming particles in the identity marker. For instance, a subset of the identity-forming particles may be the identity-forming particles that respond to a stimulus in a particular range of field strength, frequency, polarization, etc. For example, a camera may be used to observe only the diamond particles with an optical response to a specific frequency band, e.g., 2.77 to 2.79 Gigahertz (GHz) or another frequency band.

In examples where the scanner system is configured to inspect color centers of diamond particles, the scanner system includes one or more probes configured to obtain fluorescence images of the sample, for instance, by applying illumination to the sample and detecting the object's fluorescence response (e.g., over a range of applied static magnetic fields, applied static electric fields, etc.). In some examples, the scanner system also includes one or more probes configured to obtain magnetic resonance properties of the sample, for instance, by positioning the sample in an external magnetic field, applying radio or microwave pulses to the identity marker, and detecting the response of the identity marker to the pulses. The scanner system may be implemented as the scanner system 128 in FIG. 1B or in another manner.

At 412, an identifier is generated from the detected properties. In some implementations, an identifier is generated, by operation of a computer system (e.g., the computer system 122 of the example system 120 in FIG. 1B) based on the detected properties and other extracted element information. The identifier of an identity maker is unique and non-cloneable. In some implementations, the identifier is associated with the identity marker in a database. The identifier can be, for example, a value having a specified form or format. For instance, the identifier can be a fixed-length binary, alphanumeric, or hexadecimal value that can be stored in memory.

In some cases, one or more of the operations shown in FIG. 4 are implemented by a computer system. For example, the scanner system that extracts information from the identity marker may include a processor that analyzes the extracted element information. Additionally or alternatively, operations may be performed by another computer system. For example, information extracted by a scanner system can be communicated to a separate computer system that is distinct (and in some cases, remote) from the scanner system.

In a general aspect, an identity marker is formed using an electrostatic printer system and an identifier of the identity marker is generated by detecting properties of identity-forming particles in the identity marker.

In a first example, a method of manufacturing an identity marker is presented. A toner mixture is received on an electrostatically charged surface of an image transfer drum in an electrostatic printer system. The toner mixture includes fusible particles and diamond particles, and the toner mixture is held to the electrostatically charged surface by an electrostatic force. The toner mixture is transferred onto a substrate from the electrostatically charged surface of the image transfer drum. The toner mixture is bonded to the substrate by operation of the fuser assembly of the electrostatic printer system. When the toner mixture is bonded onto the substrate, the fusible particles fuse to each other forming a host matrix that secures the diamond particles at fixed locations in the host matrix.

Implementations of the first example may include one or more of the following features. The toner mixture is formed and deposited into a toner cartridge. The toner mixture is received on the electrostatically charged surface from the toner cartridge. When the toner mixture is formed, the diamond particles are selected to be within a target size distribution that is compatible with the electrostatic printer system; a toner material is selected; and the selected diamond particles are mixed with the selected toner material. When the diamond particles comprise diamond particles, the target size distribution of the diamond particles includes diamond particles having a diameter in the range of 100 nanometers to 200 micrometers.

Implementations of the first example may include one or more of the following features. When the toner mixture is formed, a target weight percentage of the diamond particles in the toner mixture is selected; amounts of the selected diamond particles and the selected toner material are obtained according to the target weight percentage; and the obtained amounts of the selected diamond particles and the selected toner material are mixed. The target weight percentage of the diamond particles in the toner mixture is less than 75%. The target weight percentage of the diamond particles in the toner mixture is greater than 75%. When the toner mixture is bonded to the substrate, heat is applied to the toner mixture on the substrate. An identity marker includes the diamond particles secured in the host matrix. Properties of at least a subset of the diamond particles in the identity marker are detected, by operation of a scanner system. An identifier based on the detected properties is generated and stored in a database, where the identifier is associated with the identity marker.

In a second example, a system includes an electrostatic printer system. The electrostatic printer system includes a toner cartridge that contains a toner mixture, an image transfer drum and a fuser assembly. The image transfer drum includes an electrostatically charged surface for receiving a toner mixture. The toner mixture includes fusible particles and diamond particles, and the toner mixture is held onto the electrostatically charged surface of the image transfer drum by an electrostatic force and transferred to a substrate. The fuser assembly is configured to bond the toner mixture to the substrate by fusing the fusible particles to each other and thereby forming a host matrix that secures the diamond particles at fixed locations in the host matrix.

Implementations of the second example may include one or more of the following features. The diamond particles are selected to be within a target size distribution that is compatible with the electrostatic printer system; a toner material is selected; and the selected diamond particles are mixed with the selected toner material. The target size distribution of the diamond particles includes diamond particles having a diameter in the range of 100 nanometers to 200 micrometers.

Implementations of the second example may include one or more of the following features. A target weight percentage of the diamond particles in the toner mixture is selected; amounts of the selected diamond particles and the selected toner material are obtained according to the target weight percentage; and the obtained amounts of the selected diamond particles and the selected toner material are mixed. The target weight percentage of the diamond particles in the toner mixture is less than 75%. The target weight percentage of the diamond particles in the toner mixture is greater than 75%. The fuser assembly includes a heating element which is configured to apply heat to the toner mixture on the substrate. The identity marker includes the diamond particles secured in the host matrix. The system further includes a scanner system and a computer system. The scanner system is configured to detect properties of at least a subset of the diamond particles in the identity marker. The computer system is configured to generate an identifier based on the detected properties and to associate the identifier with the identity marker in a database.

In a third example, a method of manufacturing an identity marker is presented. A toner mixture is received on an electrostatically charged surface of an image transfer drum in an electrostatic printer system. The toner mixture includes fusible particles and identity-forming particles, and the toner mixture is held to the electrostatically charged surface by an electrostatic force. The toner mixture is transferred onto a substrate from the electrostatically charged surface of the image transfer drum. The toner mixture is bonded to the substrate by operation of the fuser assembly of the electrostatic printer system. When the toner mixture is bonded onto the substrate, the fusible particles fuse to each other forming a host matrix that secures the identity-forming particles at fixed locations in the host matrix.

Implementations of the third example may include one or more of the following features. The toner mixture is formed and deposited into a toner cartridge. The toner mixture is received on the electrostatically charged surface from the toner cartridge. The identity-forming particles includes diamond particles. When the toner mixture is formed, the identity-forming particles are selected to be within a target size distribution that is compatible with the electrostatic printer system; a toner material is selected; and the selected identity-forming particles are mixed with the selected toner material. When the identity-forming particles comprise diamond particles, the target size distribution of the diamond particles includes diamond particles having a diameter in the range of 100 nanometers to 200 micrometers.

Implementations of the third example may include one or more of the following features. When the toner mixture is formed, a target weight percentage of the identity-forming particles in the toner mixture is selected; amounts of the selected identity-forming particles and the selected toner material are obtained according to the target weight percentage; and the obtained amounts of the selected identity-forming particles and the selected toner material are mixed. When the identity-forming particles include diamond particles, the target weight percentage of the diamond particles in the toner mixture is less than 75%. When the identity-forming particles include diamond particles, the target weight percentage of the diamond particles in the toner mixture is greater than 75%. When the toner mixture is bonded to the substrate, heat is applied to the toner mixture on the substrate. An identity marker includes the identity-forming particles secured in the host matrix. Properties of at least a subset of the identity-forming particles in the identity marker are detected, by operation of a scanner system. An identifier based on the detected properties is generated and stored in a database, where the identifier is associated with the identity marker.

In a fourth example, a system includes an electrostatic printer system. The electrostatic printer system includes a toner cartridge that contains a toner mixture, an image transfer drum and a fuser assembly. The image transfer drum includes an electrostatically charged surface for receiving a toner mixture. The toner mixture includes fusible particles and identity-forming particles, and the toner mixture is held onto the electrostatically charged surface of the image transfer drum by an electrostatic force and transferred to a substrate. The fuser assembly is configured to bond the toner mixture to the substrate by fusing the fusible particles to each other and thereby forming a host matrix that secures the identity-forming particles at fixed locations in the host matrix.

Implementations of the fourth example may include one or more of the following features. The identity-forming particles include diamond particles. The identity-forming particles are selected to be within a target size distribution that is compatible with the electrostatic printer system; a toner material is selected; and the selected identity-forming particles are mixed with the selected toner material. When the identity-forming particles include diamond particles, the target size distribution of the diamond particles includes diamond particles having a diameter in the range of 100 nanometers to 200 micrometers.

Implementations of the fourth example may include one or more of the following features. When the identity-forming particles include diamond particles, a target weight percentage of the diamond particles in the toner mixture is selected; amounts of the selected diamond particles and the selected toner material are obtained according to the target weight percentage; and the obtained amounts of the selected diamond particles and the selected toner material are mixed. The target weight percentage of the diamond particles in the toner mixture is less than 75%. The target weight percentage of the diamond particles in the toner mixture is greater than 75%. The fuser assembly includes a heating element which is configured to apply heat to the toner mixture on the substrate. The identity marker includes the identity-forming particles secured in the host matrix. The system further includes a scanner system and a computer system. The scanner system is configured to detect properties of at least a subset of the identity-forming particles in the identity marker. The computer system is configured to generate an identifier based on the detected properties and to associate the identifier with the identity marker in a database.

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media.

Some of the operations described in this specification can be implemented as operations performed by a data processing apparatus on data stored on one or more computer-readable storage devices or received from other sources.

The term “data-processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1.-19. (canceled)

20. A method comprising:
receiving a toner mixture on an electrostatically charged surface of an image transfer drum in an electrostatic printer system, wherein the toner mixture comprises fusible particles and identity-forming particles, and the toner mixture is held to the electrostatically charged surface by an electrostatic force;
transferring the toner mixture onto a substrate from the electrostatically charged surface of the image transfer drum; and
bonding the toner mixture to the substrate by operation of a fuser assembly of the electrostatic printer system to produce an identity marker wherein bonding the toner mixture onto the substrate causes the fusible particles to fuse to each other, thereby forming a host matrix that secures the identity-forming particles at fixed locations in the host matrix.

21. The method of claim 20, wherein the identity-forming particles comprise diamond particles.

22. The method of claim 20, comprising:
forming the toner mixture; and
depositing the toner mixture into a toner cartridge,
wherein the toner mixture is received on the electrostatically charged surface from the toner cartridge.

23. The method of claim 22, wherein forming the toner mixture comprises:
selecting the identity-forming particles to be within a target size distribution that is compatible with the electrostatic printer system;
selecting a toner material; and
mixing the selected the identity-forming particles with the selected toner material.

24. The method of claim 23, wherein the identity-forming particles comprise diamond particles, and the target size distribution of the diamond particles comprises diamond particles having a diameter in the range of 100 nanometers to 200 micrometers.

25. The method of claim 23, wherein the identity-forming particles comprise diamond particles, and forming the toner mixture comprises:
selecting a target weight percentage of the diamond particles in the toner mixture;
obtaining amounts of the selected diamond particles and the selected toner material according to the target weight percentage; and
mixing the obtained amounts of the selected diamond particles and the selected toner material.

26. The method of claim 25, wherein the target weight percentage of the diamond particles in the toner mixture is less than 75%.

27. The method of claim 25, wherein the target weight percentage of the diamond particles in the toner mixture is greater than 75%.

28. The method of claim 20, wherein bonding the toner mixture to the substrate comprises applying heat to the toner mixture on the substrate.

29. The method of claim 20, wherein the identity marker comprises:
at least a portion of the host matrix bonded to the substrate; and
at least a portion of the identity-forming particles secured in the host matrix.

30. The method of claim 29, comprising:
by operation of a scanner system, detecting properties of at least a subset of the identity-forming particles in the identity marker;
by operation of a computer system, generating an identifier based on the detected properties; and
in a database, associating the identifier with the identity marker.

31. A system comprising:
an electrostatic printer system comprising:
a toner cartridge containing a toner mixture, wherein the toner mixture comprises fusible particles and identity-forming particles;
an image transfer drum comprising an electrostatically charged surface configured to:
receive the toner mixture from the toner cartridge;
hold the toner mixture by an electrostatic force; and
transfer the toner mixture to a substrate; and
a fuser assembly configured to bond the toner mixture to the substrate to produce an identity marker by fusing the fusible particles to each other, thereby forming a host matrix that secures the identity-forming particles at fixed locations in the host matrix.

32. The system of claim 31, wherein the identity-forming particles comprise diamond particles.

33. The system of claim 31, comprising a mixer system configured to form the toner mixture by mixing selected identity-forming particles with selected toner material.

34. The system of claim 33, wherein the selected identity-forming particles comprise selected diamond particles and the selected diamond particles have a diameter in the range of 100 nanometers to 200 micrometers.

35. The system of claim 33, wherein the selected identity-forming particles comprise selected diamond particles, and the mixer system is configured to obtain amounts of the selected diamond particles and the selected toner material according to a target weight percentage of the selected diamond particles in the toner mixture.

36. The system of claim 35, wherein the target weight percentage of the selected diamond particles in the toner mixture is less than 75%.

37. The system of claim 35, wherein the target weight percentage of the selected diamond particles in the toner mixture is greater than 75%.

38. The system of claim 31, wherein the fuser assembly comprises a heating element configured to apply heat to the toner mixture on the substrate.

39. The system of claim 31, further comprising a scanner system configured to receive the identity marker comprising:
at least a portion of the host matrix bonded to the substrate; and
at least a portion of the identity-forming particles secured in the host matrix.

40. The system of claim 39,
wherein the scanner system is configured to detect properties of at least a subset of the identity-forming particles in the identity marker; and
the system comprises a computer system configured to generate an identifier based on the detected properties and to associate the identifier with the identity marker in a database.
